(19) United States
(12) Patent Application Publication
(10) Pub. No.: US 2008/0197060 A1
(43) Pub. Date: Aug. 21, 2008

(54) Double Acting Fuel Filter Unit

(75) Inventor: Giorgio Girondi, Mantova (IT)

Correspondence Address: BROWDY AND NEIMARK, P.L.L.C.;624 NINTH STREET, NW, SUITE 300, WASHINGTON, DC, 20001-5303, US

(73) Assignee: UFI FILTERS S.P.A., PORTO MANTOVANO (IT)

(21) Appl. No.: 11/917,629

(22) PCT Filed: May 23, 2006
(86) PCT No.: PCT/EP06/04886

§ 371 Date: Dec. 14, 2007

(30) Foreign Application Priority Data
Jun. 20, 2005 (IT) RE2005A00069

(51) Int. Cl. B01D 29/58

(52) U.S. Cl. 210/86; 210/416.4; 210/258

(57) ABSTRACT

Double acting fuel filter unit comprising a first pre-filter (14) and a second fine filter element (140) connected in series by suitable conduits, wherein said first and second element are supported by the lower and upper opposing sides respectively of a single block (1) within which there are positioned: a pump (23, 24, 25) for priming the pre-filter with fuel, a first conduit (3) which connects the lower side of the block to the fuel tank, a second conduit (4) and a third conduit (6) which connect the upper side of the block to the compartment (2) of the priming pump (23, 24, 25), a fourth conduit (7) which connects the upper side of the block to the engine feed conduit, and a fifth conduit (70) which connects the upper surface of the block to the lateral surface thereof; to the lower surface of the block there being fixed a cup casing containing the pre-filter (14), and within which there open said first and second conduit upstream and downstream of the pre-filter 14 respectively; to the upper side of the block there being fixed a second cup casing containing the filter (140), and within which there open said fourth conduit (7) and fifth conduit (70) upstream and downstream of the filter (140) respectively.

### TECHNICAL FIELD

The typical fuel (diesel fuel) feed circuit of compression-ignition power units with which medium-light, medium and heavy industrial vehicles are equipped is of complicated construction. From the tank, the fuel is initially fed to a complete pre-filter for high water separation, which because of its dimensions is usually fixed to the vehicle frame.

### PRIOR ART

The complete pre-filter is installed in the intake side of the feed circuit, and generally comprises an aluminium support block in which the filling pump, manually operable by the user, is located.

An electric heater and a temperature sensor or alternatively a thermostat are usually installed in the support block.

The purpose of the pre-filter is to separate the water present in the fuel and to provide coarse filtering of impurities.

The pre-filter comprises a filter cartridge and a container, also known as a cup, which contains it.

The cup of the pre-filter is normally made of metal and is of so-called “screwable” type because of its method of installation.

A water presence indicator is inserted into the base of the cup containing the pre-filter via a threaded connection.

The pre-filtered fluid fuel (diesel fuel), free of emulsified water by the effect of the pre-filter coalescence action and heated by the electric heater, is drawn by a feed pump. The feed pump of the fuel circuit hence “draws” the fuel (diesel fuel) from the pre-filter and provides it with the energy required for feeding the fine filter unit.

The fine filter unit is normally installed on the engine and consists of an aluminium metal block which comprises the seat for a clogging indicator and a fine filter cartridge.

The fine filter cartridge is also contained in a cup, generally of screwable type, which is made of metal and is connected to the aluminium block by a threaded connection.

The aforestated state of the art presents drawbacks in terms of cost, due to the large number of components, of complicated assembly requirements, and of operative difficulties due to the complicated coordination of the various parts.

The object of the present invention is to overcome the drawbacks of the known art by a simple and economical solution.

### DISCLOSURE OF THE INVENTION

This object is attained according to the invention by a device in which the aforedescribed functions are integrated into a single block with relative filter units, as further defined in claim 1.

The two filter units, connected to the same block in accordance with the invention, are separate and make it possible to effect the following mutually coordinated operations:

separate the dissolved water in intimate emulsion with the fluid fuel (diesel fuel), pre-filter this latter and heat it;

control the activation and deactivation of the heater, with consequent limitation of electrical absorption;

by installing an electric pump, automatically prime the filter unit installed downstream of the fuel tank (hence under suction);

indicate the presence of water separated by coalescence within the collection container, positioned immediately below the pre-filter;

effect fine filtering of the fuel (diesel fuel) before its feed into the feed circuit of the power unit;

indicate clogging of the filter cartridge by measuring the pressure drop.

### BRIEF DESCRIPTION OF THE DRAWINGS

The characteristics and merits of the invention will be apparent from the ensuing detailed description illustrated in the figure of the accompanying drawing, which shows a preferred embodiment thereof by way of non-limiting example.

FIG. 1 is a section through the preferred embodiment of the invention.

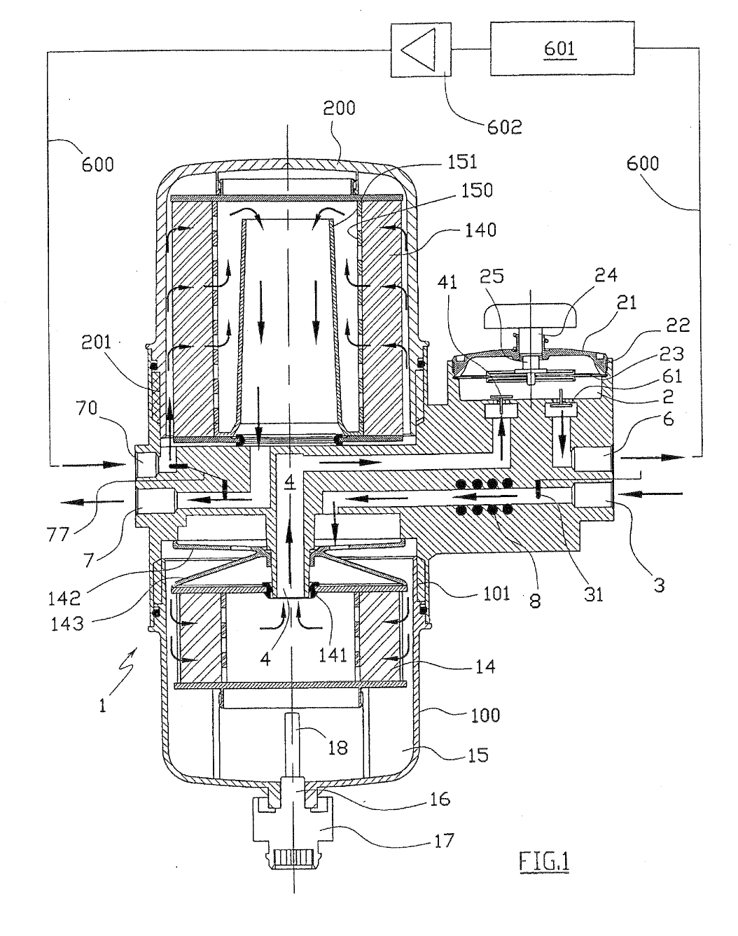

### BEST MODE FOR CARRYING OUT THE INVENTION

The figure shows a synthetic material block 1 having a lower and an upper flat surface and comprising a compartment 2.

In the block there are also present a first conduit 3 which connects the side wall of the block to its lower flat surface, and a second conduit 4 which connects the lower flat surface of the block to the compartment 2.

The compartment 2 is circular and is closed by a disc 21 from which a skirt 22 descends carrying an elastic membrane 23.

The disc 21 presents the seat for a coil 24, the centre of which slidingly receives a rod 25 fixed to the centre of the membrane 23.

The compartment 2 is connected to the lower side of the block I by the conduit 4 which is valved by a mushroom valve 41 opening only towards the inside of the compartment 2.

The compartment 2 is connected to the outer surface of the block by a third conduit 6 which is valved by a mushroom valve 61 opening only towards the outside of the compartment 2.

The valve 41 is maintained closed by a calibrated spring and is connected to the electronic control system of the invention, which senses its open or closed state.

The block 1 lowerly receives, fixed by threaded means 101, a first cup casing 100 containing the disposable pre-filter or filter cartridge 14.

The pre-filter 14 presents a central hole 141 sealedly coupled to the conduit 4, and an upper holed flange 142 coupled to the lower side of the block 1 external to the end of the conduit 3.

Between the holed flange 142 and the pre-filter 14 there is a conical wall 143 of coalescence material, which separates the water from the fuel before this reaches the pre-filter.

At the base of the cup 100 a chamber 15 is present, connected to the outside via a hole 16 closed by a cock 17 controlled by the electronic control system.

A level sensor 18 indicates the water level which causes the cock 17 to open.

A resistance heating element 8 is positioned about the conduit 3.

The block 1 is arranged to upperly receive, fixed thereto by threaded means 201, a second cup casing 200 containing the disposable filter 140 for fine filtration.

The filter 140 comprises a central holed tube 150 connected to an internal solid-walled coaxial tube 151.

The tube 151 is sealedly faced by a fourth conduit 7 which connects the upper surface of the block to its lateral wall.

The block also presents a fifth conduit 70 which connects its upper side, within the cup casing but external to the filter 140, to the external surface of the block.

A temperature sensor 31 located within the first conduit 3 is connected to the electronic control system of the device.

An electronic card, not shown, receives the signals from the valve 41, the level sensor 18 and the temperature sensor 31.

The card is connected to a terminal strip, not shown, to be connected in its turn to signal processor means and actuator means present on the vehicle.

The terminal strip 312 also presents the power terminals for the resistance element 8 and the terminals for the temperature sensor.

The aforedescribed filter unit is installed on the vehicle by connecting the conduit 3 to the fuel tank and the conduit 7 to the engine fuel feed circuit.

The conduits 6 and 70 are connected together by a tube 600 external to the device, into which a cooler device 601 and a 5 bar pump 602 can be connected.

The device of the invention, when installed on the engine, operates in the following manner.

The conduit 3 of the block 1 is connected to the fuel tank, not shown in the figure.

The fluid fuel flow (diesel fuel) strikes the temperature sensor 31, which activates the resistance heater element 8 on the basis of the measured temperature.

If the measured temperature is less than zero degrees centigrade, the electronic control system activates the heater, which transfers heat to the fluid fuel flow (diesel fuel) to hence dissolve any paraffin grains contained therein and formed by the effect of low temperature.

If the temperature of the fluid fuel (diesel fuel) flowing towards the pre-filter region measured by the sensor is greater then zero degrees centigrade, the heater controlled by the sensor 31 does not operate.

The fuel flow (diesel fuel) undergoes a first filtration stage with relative separation of water by coalescence in the first cup casing 100, in which the water is also separated by coalescence.

On leaving the cup casing 100 downstream of the pre-filter 14, the fuel is drawn into the compartment 2 through the conduit 4 by the electric filling pump consisting of the membrane 23 operated by the coil 24 via the rod 25. Access to and withdrawal from the compartment 2 is by a suitable system of valves which operate in synchronism: during the intake stage of the filling pump the pump delivery valve 61 remains closed, whereas during the pump delivery stage its intake valve 41 remains closed.

The filling pump can be of membrane type operated by a solenoid, as shown, or by a DC motor. It is powered electrically and can be controlled automatically by the control system or manually by a branch (switch and/or pushbutton) on the instrument panel, to prevent formation of air bubbles in the engine feed circuit.

Downstream of the pump the fuel passes through the valve 61 and the conduit 6 to leave the block 1 and pass into the conduit 600, through which the fuel reaches the conduit 70 of the block 1, which feeds it into the second cup casing 200, where it undergoes fine filtration by the filter 140.

After passing through the fine filter 140 the fuel passes into the conduit 7 connected to the engine feed circuit.

A clogging sensor 77 of differential pressure type connected between the conduits 7 and 70 indicates when a threshold value is exceeded, beyond which the filter 140 must be replaced

1. A double acting fuel filter unit comprising a first pre-filter (14) and a second fine filter (140) connected in series by suitable conduits, characterised in that said first and second element are supported by the lower and upper opposing sides respectively of a single block (1) within which there are positioned: a pump (23, 24, 25) for priming the pre-filter with fuel, a first conduit (3) which connects the tower side of the block to the fuel tank, a second conduit (4) and a third conduit (6) which connect the upper side of the block to the compartment (2) of the priming pump (23, 24, 25), a fourth conduit (7) which connects the upper side of the block to the engine feed conduit, and a fifth conduit (70) which connects the upper surface of the block to the lateral surface thereof; to the lower surface of the block there being fixed a cup casing containing the pre-filter (14), and within which there open said first and second conduit upstream and downstream of the pre-filter (14) respectively; to the upper side of the block there being fixed a second cup casing containing the filter (140), and within which there open said fourth conduit (7) and fifth conduit (70) upstream and downstream of the filter (140) respectively.

2. A unit as claimed in claim 1, characterised in that the block comprises one or more of the following devices: a temperature indicator located in the second conduit; a water level indicator located at the base of the first cup; a clogging indicator located between the fourth conduit (7) and the fifth conduit (70); a resistance heater (8) located about the first conduit (3).

3. A unit as claimed in claim 1, characterised in that the pre-filtered fuel outlet conduit (6) is connected to the inlet conduit (70) of the filter (140) by a conduit (600).

4. A unit as claimed in claim 3, characterised in that a cooler device (601) and a circulation pump (602) are connected in series into the conduit (600).
